(19) United States
(12) Patent Application Publication
(10) Pub. No.: US 2011/0123785 A1
(43) Pub. Date: May 26, 2011

(54) NON-LATEX LAMINATED BALLOONS CONTAINING PIGMENT AND RELATED METHODS

(76) Inventors: Arturo Verduzco Garcia, Gudalajara (MX); Andres Avelino Guzman Orozco, Guadalajara (MX)

(21) Appl. No.: 12/950,705

(22) Filed: Nov. 19, 2010

Related U.S. Application Data
(60) Provisional application No. 61/263,117, filed on Nov. 20, 2009.

(51) Int. Cl. B32B 3/10; B32B 27/32; B32B 27/08; B32B 37/12; B31B 1/62

(52) U.S. Cl. 428/203; 428/523; 428/476.9; 428/518; 156/292; 156/60

(57) ABSTRACT

A laminated balloon and methods of making same. The laminated balloons can be two-ply or three-ply. The laminated balloons have a color imbedded in them through the use of pigments in the plies and the adhesives used to create the laminated balloons. Other materials, such as glitter and crushed mica, can be added to the plies and the adhesive to add visual effects to the balloons.

### PRIORITY

This application claims the benefit of U.S. Provisional Application No. 61/263,117, filed on Nov. 20, 2009, entitled “NON-LATEX LAMINATED BALLOONS CONTAINING PIGMENT AND RELATED METHODS,” naming Arturo Verduzco Garcia and Andres Avelino Guzman Orozco as inventors, which is hereby incorporated by reference in its entirety.

### BACKGROUND OF THE INVENTION

1. Field of the Invention

The invention relates to laminated balloons and related methods of producing same.

2. Description of the Related Art

Balloons can be used for a variety of purposes, such as meteorology and medical treatment, but the most common use is as a decoration. Balloons can be made from materials such as rubber, latex, polychloroprene, or a nylon fabric. Balloons can be single-ply, such as latex balloons, or multi-layer or ply, such as laminated foil balloons. Various types of gases or liquids can be used to inflate balloons. Helium is particularly popular since it enables balloons to “float.”

The use of laminated balloons has significantly increased through the years because they can hold the gas required to inflate the balloons for an extended period of time. Laminated balloons work particularly well with helium as the inflating medium since regular latex balloons cannot hold helium for more than about a day or so. The enclosed helium atoms escape through small pores in the latex that are typically larger than the helium atoms.

To make a laminated balloon, at least two films are laminated. In a typical balloon, a first film (A) is supplied that is typically nylon or polyester. Depending on the specification of the nylon or polyester, the first film (A) may or may not have a metallic layer on one of the faces of the first film (A). If the first film (A) has a high barrier specification, then the metallic layer may not be needed. If the first film (A) does not have a high barrier specification, a metallic layer will be added to the first film (A). The second film (B) that is used to form the balloon is typically polyethylene. The second film (B) is typically natural colored (i.e., no color or transparent). An adhesive is positioned between the first film (A) and the second film (B).

The films (A) and (B) are then laminated with the adhesive and processed to form a roll of a multi-ply laminated substrate. The multi-ply laminated substrate is then sent to an oven with temperature control to complete the lamination process.

The laminated substrate is then cut into standard sizes as needed to form balloons. The substrate is then printed typically using flexography or rotogravure printing processes on the film (A) side of the substrate. After printing, the substrate is then converted into a balloon, using a converting machine with cutting dies.

A few disadvantages exist in the standard process of producing substrates that are used to produce balloons. One disadvantage is that, because the printing is externally exposed on the finished balloon (on the first film (A) side), the printing is subject to the elements. Humidity and rain can affect the printing on the substrate causing smearing or similar issues. Besides the weather, the balloon can easily be scratched so that the printing is affected.

Another disadvantage of the standard process of producing substrates that are used to produce balloons is that the printing process is relatively expensive. If a different colored balloon is desired, the entire face of the balloon has to be printed with the desired color.

A need exists for balloons that can withstand the rigors to which many balloons are exposed without the printing and colors being damaged. It would be advantageous if the improved balloons could also be manufactured without substantially increasing the production costs of the balloons.

### SUMMARY OF THE INVENTION

In view of the foregoing, laminated balloons having color contained therein and methods of making the same are provided as embodiments of the present invention. Besides the balloons and methods of making them, laminated substrates and methods of making the same are also provided as embodiments of the present invention.

In embodiments of the present invention, two or three ply balloons are provided. The balloons include a first film having high barrier properties, a second film comprising a resin and a pigment, and an adhesive. In some embodiments, a third film comprising a polymer selected from the group consisting of nylon, BOPP, PET, and PVC can be included.

The laminated balloons are made from laminated substrates. To make the laminated substrates described herein, the first film and the second film are provided. An adhesive is positioned between the first and second films to form an A/B substrate. The A/B substrate is then laminated to form the laminated substrate. The laminated substrate has a color embedded therein that matches the pigment contained in the second film.

In embodiments of the present invention, a third film and additional adhesive can be provided. In this embodiment, the adhesive is positioned between the first film and the third film and between the third film and the second film to form the substrate A/C/B. The A/C/B substrate is then laminated to form the laminated substrate. The laminated substrate has a color embedded therein that matches the pigment contained in the second or third films, depending on which film the pigment was added.

The second film, the third film, the adhesives, or combinations thereof can include pigment. Besides pigment, other materials that can create various effects in the substrate and the resulting balloons can be used. Examples of such materials can include additional pigment, glitter, crushed mica, crushed metals, fluorescent pigments, and the like.

### BRIEF DESCRIPTION OF THE DRAWING

FIG. 1 is a cross-sectional view of two films and an adhesive before lamination used to produce a substrate in accordance with embodiments of the present invention;

FIG. 2 is a cross-sectional view of a substrate containing two films and an adhesive in accordance with embodiments of the present invention;

FIG. 3 is a cross-sectional view of three films and an adhesive before lamination used to produce a substrate in accordance with embodiments of the present invention;

FIG. 4 is a cross-sectional view of a substrate containing three films and an adhesive in accordance with embodiments of the present invention;

FIG. 5 illustrates a process of extruding a resin to produce a polymeric film in accordance with prior art methods; and

FIG. 6 illustrates a process of extruding a resin containing pigment to produce a polymeric film in accordance with embodiments of the present invention.

While the invention is susceptible to various modifications and alternative forms, specific embodiments have been shown by way of example in the drawings and will be described in detail herein. However, it should be understood that the invention is not intended to be limited to the particular forms disclosed. Rather, the intention is to cover all modifications, equivalents and alternatives falling within the spirit and scope of the invention as defined by the appended claims.

### DESCRIPTION OF ILLUSTRATIVE EMBODIMENTS

Laminated balloons having color embedded therein and methods of making the same are provided as embodiments of the present invention. Besides the balloons and methods of making the same, laminated substrates and methods of making the same are also provided as embodiments of the present invention.

In embodiments of the present invention, two or three ply substrates are used to produce the balloons. The substrates include a first film having high barrier properties, a second film comprising a resin and a pigment, and an adhesive. In some embodiments, a third film comprising a polymer selected from the group consisting of nylon, BOPP, PET, and PVC can be included.

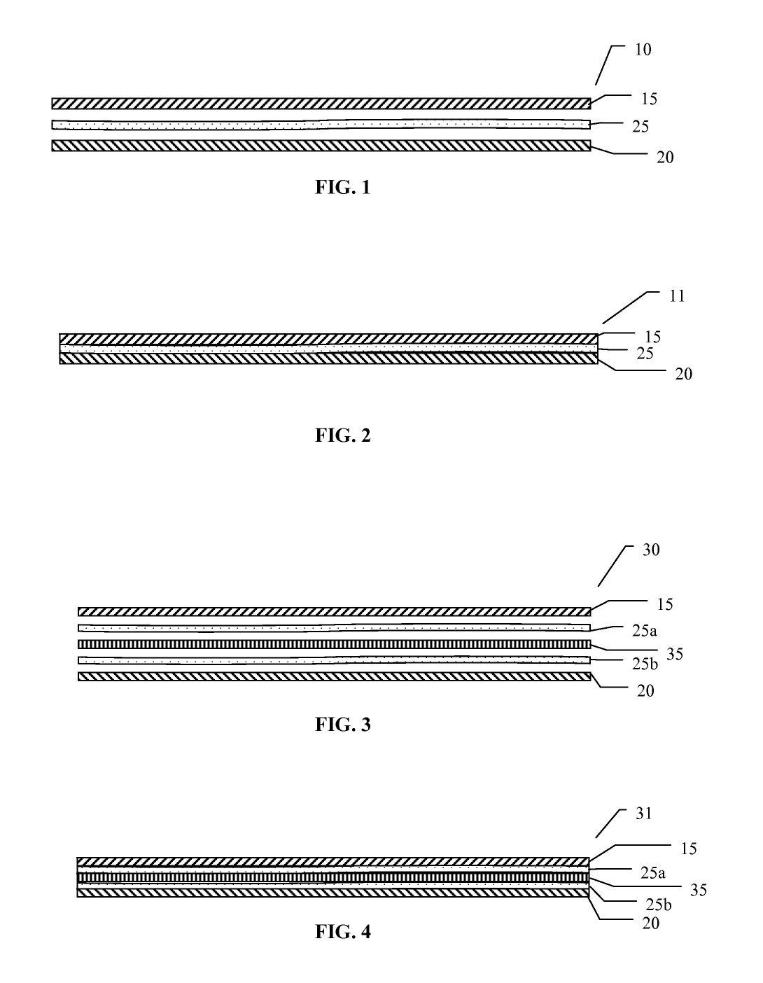

FIGS. 1-4 illustrate the two- and three-ply substrates that contain a color embedded therein. The substrates can be formed into balloons.

As shown in FIG. 1, in order to make the high barrier substrate 10 that can be used to make a balloon, a film 15 is supplied that comprises a polymer having a high barrier specification. Suitable materials that can be used for the high barrier films can include coated bi-axially oriented polypropylene (BOPP) film, coated cellophane, coated polyester (PET) film, and the like. A particularly suitable high barrier film is commercially available from Itochu. Other materials that can be used as high barrier films in embodiments of the present invention will be apparent to those of skill in the art and are to be considered within the scope of the present invention.

In an aspect, the high barrier film useful in embodiments of the present invention has an oxygen transmission rate of below about 1.5 cc/m²/day. The oxygen transmission rate can be varied, as required for the particular application in which the substrate or balloon will be used.

To make the substrates and balloons described herein, a second film 20 is supplied that comprises a mixture of medium density resins and low density resins. In an aspect, the mixture can be 50:50 medium density resin:low density resin. In an aspect, the second film comprises polyethylene. In another aspect, the second film 20 also comprises pigment. By adding pigment to the second film 20, color is added to the film 20 during fabrication of the second film 20, as shown in FIG. 6, so that the resulting film 20 has the color from the pigment embedded in it. The resulting film 20 can be used to make balloons that have color embedded in an inner layer of the balloon so that the color is protected from the elements and external forces.

In an aspect of the present invention, the second film 20 can have indicia printed thereon so that the indicia can be seen once the balloon is formed. Because the first film 15 is transparent, the indicia printed on the second film 20 can easily be seen through the balloon. The indicia can be reverse printed on an inner side of the first film 15 so that the printed indicia is located in the center of the formed balloon, as will be understood by those of skill in the art. The indicia can include words, pictures, symbols, and the like. If the indicia is printed on the second film 20, there is no need to send the substrate for external printing prior to forming the balloon.

As referred to herein, the term “pigment” used in the films, adhesives, or combinations thereof generally refers to chemical pigments, colorants, inks, and the like that can be used to add color to the substrates and balloons formed therefrom. The pigment will enable the finished substrates 11, 31 and resulting balloons to have various colors, such as blue, pink, fluorescent, phosphorescent, and the like embedded therein. The pigments can be organic or inorganic. Suitable types of materials that can be used to color the films and adhesives described herein will be apparent to those of skill in the art and are to be considered within the scope of the present invention.

The films 15, 20 are then converted into a single substrate 11, as shown in FIG. 2. The single substrate 11 can be formed into balloons. The single substrate 11 can be formed by the joining films 15, 20. One method of joining the films 15, 20 is lamination using adhesives. In this process, an adhesive 25 is positioned between the first film 15 and the second film 20. The first film 15, second film 20, and adhesive 25 are then laminated to form the single substrate 11. The single substrate 11 can be produced in rolls. In an aspect, after the initial lamination step the new substrate 10 is sent to an oven with temperature control to complete the lamination process, as will be understood by those of skill in the art.

In an aspect, the adhesive 25 is a solvent-less adhesive. The adhesive can include a urethane-based adhesive and a catalyst. Suitable types of adhesives that can be used in embodiments of the present invention will be apparent to those of skill in the art and are to be considered within the scope of the present invention.

Besides adding pigment to the films and adhesives, other types of materials can be used to provide colors or visual effects in the films and/or adhesives and the resulting balloons. For example, crushed mica can be used to produce pearl tones in the films and adhesives. Crushed metal can be used to produce metallic tones in the films and adhesives. In an aspect, the adhesive can include additional pigment, glitter, crushed mica, crushed metal, fluorescent pigments, or combinations thereof. The additional pigment in the adhesive 25 can be the same color as the pigment contained in the second film 20 or can be different. Other suitable effects or materials that can be added to the adhesive 25 to change the appearance of the substrate 10 or the formed balloons will be apparent to those of skill in the art are to be considered within the scope of the present invention.

The films used to produce the substrates and balloons described herein can also include various types of additives, as needed, such as a processing aid. Suitable types of additives that can be used in embodiments of the present invention will be apparent to those of skill in the art and are to be considered within the scope of the present invention.

Once the rolls of the substrate 10 are produced, the substrate 10 can be formed into balloons. The step of forming the balloon can include cutting the substrate 10 to the standard sizes according to the size of the balloons to be produced, followed by converting the substrate 10 into balloons. In an aspect, the substrate 10 can be converted to balloons using a converting machine with cutting dies, as will be understood by those of skill in the art. Other suitable methods of converting the substrate 10 to balloons will be apparent to those of skill in the art and are to be considered within the scope of the present invention.

In an aspect, the balloon and substrate embodiments of the present invention are generally non-metal. The balloons and substrates generally use films having high barrier properties. The high barrier properties of the first film 15 provide a sufficient barrier to hold the medium that is being used to inflate the balloon for an extended period of time. The use of metal coatings and films is not needed in the present invention.

As another embodiment of the present invention a balloon comprising three films 15, 20, is provided, as shown in FIGS. 3 and 4. The first film 15 that is used to form the balloon comprises a transparent high barrier film. The second film 20 that is used to form the balloon comprises a resin and a pigment. In an aspect, the resin contained in the second film 20 comprises polyethylene. The third film 35 that is used to form the balloon comprises a polymer selected from the group consisting of nylon, BOPP, PET, and PVC. The adhesive 25a, 25b is positioned between the first film 15 and the third film 35 and between the third film 35 and the second film 20 so that when the first film 15, the second film 20, the third film 35, and the adhesive 25a, 25b are laminated, the laminated substrate 31 has a color embedded in the laminated substrate 31 corresponding to the pigment.

As indicated herein, besides adding pigment to the second film 20, the third film 35 can also include additional pigment. Similar to the pigment in the adhesive 25, the additional pigment in the third film 35 can be the same color as the pigment contained in the second film 20 or can be different. The adhesive can also include pigment that is the same or different than the films 20, 35. In an aspect, the second film 20, the third film 35, and the adhesive 25 can all have a different colored pigment to vary the colors of the substrate and balloons.

In an aspect, the amount of pigment used in the films 20, 35 and in the adhesive 25 can be varied depending upon the desired effect. For example, if an intense color or effect is desired, the amount of pigment contained in the films 20, 35 or adhesive 25 can be increased. Any amount of pigment that will achieve the desired color or effect can be used. In an aspect, the pigment is present in the films 20, 35 or the adhesive 25 in a range of about 1 wt. % to about 20 wt. %; alternatively, in a range of about 10 wt. % to about 15 wt. %. Other suitable amounts of pigment will be apparent to those of skill in the art and are to be considered within the scope of the present invention.

As another embodiment of the present invention, a non-metal laminated balloon is provided. In this embodiment, the non-metal laminated balloon is formed from a substrate that includes a first film 15, a second film 20, and an adhesive 25. The first film 15 comprises a transparent high barrier film. The second film 20 comprises a resin and a pigment. The adhesive 25 is positioned between the first film 15 and the second film 20 so that when the first film 15, the adhesive 25, and the second film 20 are laminated, the laminated substrate 10 that is used to form the laminated balloon has a color embedded in the balloon that matches the pigment.

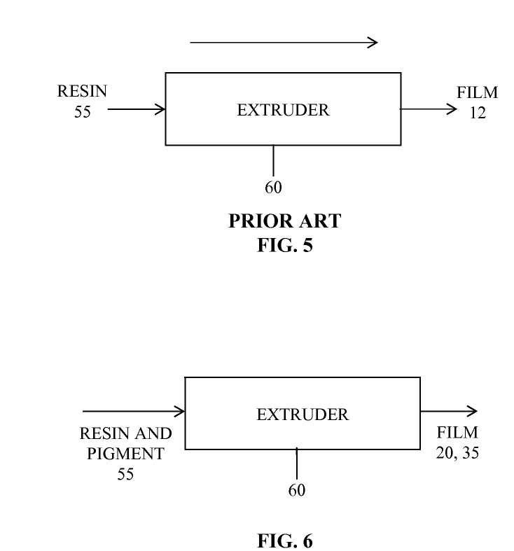

The second and third films 20, 35 are typically formed by an extrusion process, as shown in FIG. 5. In a typical extrusion process, a resin stream 55 is supplied to an extruder 60 and the film 12 is produced. The resin stream 55 can include various types of resins suitable for uses as second or third films 20, 35, as described herein. In embodiments of the present invention, the resin stream 56 includes the resin, but also includes pigment, as shown in FIG. 6. The resulting second or third film 20, 35 has a color that matches the color of the pigment supplied with the resin to the extruder 60.

In some embodiments of the present invention, the substrates are then converted into laminated balloons. Those of skill in the art will appreciate the numerous methods of producing the balloons from the laminated substrates. Any suitable method of forming balloons using the laminated substrates made in accordance with the description herein can be used in the present invention. For example, once the rolls of laminated substrates are formed and set, the rolls can be sent to a converting machine with cutting dies. Other suitable methods of forming balloons will be apparent to those of skill in the art and are to be considered within the scope of the present invention. Once the balloon is formed, the resulting balloon has a color embedded in it that matches the pigment used in producing the laminated substrate.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations can be applied to the compositions and/or methods and in the steps or in the sequence of steps of the methods described herein without departing from the concept, spirit and scope of the invention. More specifically, it will be apparent that certain agents that are chemically related can be substituted for the agents described herein or additional films can be used to produce the substrates and the balloons while the same or similar results would be achieved. All such similar substitutes and modifications apparent to those skilled in the art are deemed to be within the scope and concept of the invention.

What is claimed is:

1. A non-metal laminated balloon comprising:
a. a first film comprising a transparent high barrier film;
b. a second film comprising a resin and a pigment; and
c. an adhesive positioned between the first film and the second film so that when the first film, the adhesive, and the second film are laminated, the laminated substrate has a color embedded in the laminated substrate that matches the pigment.

2. The balloon according to claim 1, wherein pigment is present in a range of about 1 wt. % to about 20 wt. % and wherein the resin comprises polyethylene.

3. The balloon according to claim 1, wherein the adhesive comprises additional pigment, glitter, crushed mica, crushed metal, fluorescent pigments, or combinations thereof.

4. The balloon according to claim 1, wherein the transparent high barrier film has an O₂ transmission rate below about 1.5 cc/m²/day.

5. The balloon according to claim 1, further comprising a third film comprising a polymer selected from the group consisting of nylon, BOPP, PET, and PVC.

6. The balloon according to claim 6, wherein the second film, the third film, and the adhesive comprise a different colored pigment.

7. The balloon according to claim 1, wherein the second film comprises indicia printed thereon so that the indicia can be seen external to the balloon.

8. A non-metal laminated balloon comprising:
a. a first film comprising a transparent high barrier film;
b. a second film comprising a resin and a pigment;
c. a third film comprising a polymer selected from the group consisting of nylon, BOPP, PET, and PVC; and
d. an adhesive positioned between the first film and the third film and between the third film and the second film, the first film, the second film, the third film, and the adhesive being laminated so that the balloon has a color embedded in it that matches the pigment.

9. The balloon according to claim 8, wherein pigment is present in a range of about 1 wt. % to about 20 wt. % and the resin comprises polyethylene.

10. The balloon according to claim 8, wherein the adhesive comprises additional pigment, glitter, crushed mica, crushed metal, fluorescent pigments, or combinations thereof.

11. The balloon according to claim 8, wherein the transparent high barrier film has an O₂ transmission rate below about 1.5 cc/m²/day.

12. The balloon according to claim 8, wherein the third film further comprises additional pigment.

13. The balloon according to claim 8, wherein the second film, the third film, and the adhesive comprise a different colored pigment.

14. A method of manufacturing a non-metal laminated substrate having color embedded therein comprising the steps of:
a. providing a first film comprising a transparent high barrier film;
b. providing a second film comprising polyethylene and a pigment;
c. positioning an adhesive between the first film and the second film; and
d. laminating the first film, the adhesive, and the second film to form the non-metal laminated substrate so that the laminated substrate has an embedded color that matches the pigment.

15. The method of claim 14 further comprising the steps of:
a. providing a third film comprising a polymer selected from the group consisting of nylon, BOPP, PET, and PVC; and
b. positioning additional adhesive between the second film and the third film prior to lamination and formation of the substrate.

16. The method of claim 14, further comprising forming a laminated balloon with the non-metal laminated substrate so that the balloon has a color embedded therein.

17. The method of claim 14, wherein the pigment is present in the second film in a range of about 1 wt. % to about 20 wt. %.

18. The method of claim 14, wherein the adhesive comprises additional pigment, glitter, crushed mica, crushed metal, fluorescent pigments, or combinations thereof.

19. The method of claim 14, wherein the third film comprises additional pigment.

20. The method of claim 14, wherein the second film, the third film, and the adhesive comprise a difference colored pigment.
